(19) United States
(12) Patent Application Publication
(10) Pub. No.: US 2004/0038665 A1
(43) Pub. Date: Feb. 26, 2004

(54) Mobile telephone, and advertisement distributing method and distributing system for its use

(76) Inventor: Shizu Hosono, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/639,519

(22) Filed: Aug. 13, 2003

(30) Foreign Application Priority Data
Aug. 21, 2002 (JP) 240036/2002

(51) Int. Cl. H04B 7/15

(52) U.S. Cl. 455/404.2; 455/456.1; 455/11.1

(57) ABSTRACT

An advertisement distributing-functioned mobile telephone produces with an application in its own terminal an advertisement to be distributed, finds its position with a position finding mechanism such as a GPS, and registers its position with a data management server via a positional information server. A control unit controls other circuits in its own terminal, and selects users to whom the advertisement is to be distributed on the basis of user information acquired from the positional information server. A radio control unit acquires user information from the positional information server and distributes the advertisement.

### BACKGROUND OF THE INVENTION

1. Field of the Invention

The present invention relates to a mobile telephone, and an advertisement distributing method and program for its use, and more particularly to a method for distributing advertisements to mobile telephones.

2. Description of the Related Art

Advertisement distributing methods of this kind according to the prior art include those by which advertisements from personal computers using positional information servers and from servers are distributed and are already in practice as tourism guide information systems and like services.

For instance, the Japanese Patent Application Laid-open No. 2001-359166 discloses a technique by which distribution of advertisements is targeted on mobile telephones positioned in a specific area, the contents of the advertisements being likely to interest the users of those mobile telephones.

In this case, a distributing server causes a position detecting server to collect information on the positions of mobile telephones each with a Global Positioning System (GPS) receiver function, and identifies mobile telephones positioned in the specific area on the basis of that positional information. Afterwards, the distributing server acquires from a database information on the users of the identified mobile telephones, and decides whether to distribute an advertising message to each one of them, thereby to make the distribution of advertising messages selective.

However, the above-described advertisement distributing method according to the prior art involves a problem that, if the advertiser does not stay in a single fixed position (where the advertiser is a street stall operator or has no store in a fixed location) or has no personal computer (PC), its advertising messages cannot be distributed.

### SUMMARY OF THE INVENTION

An object of the present invention, therefore, is to obviate the problem noted above, and to provide a mobile telephone which permits distribution of advertisements even if the advertiser does not stay in a single fixed place, and an advertisement distributing method and its program to be used by the mobile telephone.

A mobile telephone according to the invention has a function to find its own position, and is further provided with a generating function to generate advertising information to be distributed, and a distributing function to distribute the advertising information which has been generated to terminals which fit preset conditions.

An advertisement distributing method for a mobile telephone having a function to find its own position according to the invention comprises a step of generating advertising information to be distributed, and a step of distributing the advertising information that has been generated to terminals which fit preset conditions.

A program of the advertisement distributing method for a mobile telephone having a function to find its own position according to the invention causes the computer of the mobile telephone to execute processing to generate advertising information to be distributed and processing to distribute the advertising information which has been generated to terminals which fit preset conditions.

Thus, the mobile telephone according to the invention capable of finding its own position via a positional information server has a function to acquire from a positional information server information on users present in a predetermined range, select within it target users for an advertisement and distribute advertising information to the users so selected.

In this way, the mobile telephone according to the invention can generate on its own an advertisement to be distributed, and by its own distributing function can distribute the advertisement even if it has no PC or server.

Since the mobile telephone according to the invention can designate the area of target users in terms of so many meters' radius from its own position or otherwise, it can find the target users even if it changes its position or is moving, so that the advertiser need not stay in one place to distribute its advertisement.

Further, since the mobile telephone according to the invention acquires positional information from a positional information server, the frequency of data exchanges can be minimized, and the period of time can be designated.

Moreover, as the mobile telephone according to the invention distributes advertising with its e-mailing function, there is no need for any new software configuration or mounting of a system for the distributing purpose. For this reason, a conventional mobile telephone capable of finding its own position can be used for advertising distribution.

In addition, the mobile telephone according to the invention, once it finds that there is no target user within the area registered with the positional information server, can readily accomplish setting to expand or alter the target area.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram illustrating the configuration of a mobile communication system, which is a preferred embodiment of the invention;

FIG. 2 is a block diagram illustrating the configuration of a mobile telephone having an advertisement distributing function;

FIG. 3 illustrates an area of registration in the preferred embodiment of the invention;

FIG. 4 is a flowchart showing the operation of the preferred embodiment of the invention; and

FIG. 5 is a sequence chart showing the operation of the preferred embodiment of the invention.

### DEATAILED DESCRIPTION OF THE PREFFERRED EMBODIMENT

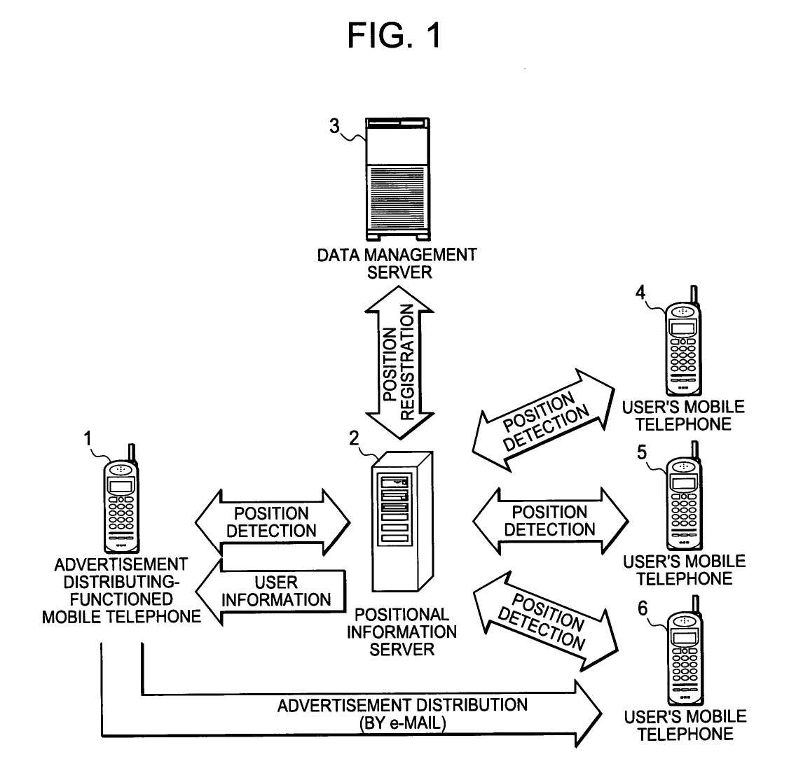

Next will be described a preferred embodiment of the present invention. FIG. 1 is a block diagram illustrating the configuration of a mobile communication system, which is the preferred embodiment of the invention. Referring to FIG. 1, the mobile communication system embodying the invention is configured of an advertisement distributing-functioned mobile telephone 1, a positional information server 2, a data management server 3 and a plurality of user's mobile telephones 4 through 6.

Although there is a radio network comprising a base station and a radio control apparatus among the advertisement distributing-functioned mobile telephone 1, the user's mobile telephones 4 through 6 and the positional information server 2, it is not illustrated in FIG. 1.

The advertisement distributing-functioned mobile telephone 1 can find its own position by using a Global Positioning System (GPS) or the like. The positional information server 2 provides positional information service, and the data management server 3 manages positional information, accepts registration of target areas and manages user information.

Each of the user's mobile telephones 4 through 6 can find its own position, and registers the found position with the data management server 3 via the positional information server 2. In other words, each of the user's mobile telephones 4 through. 6 can receive service from the positional information server 2.

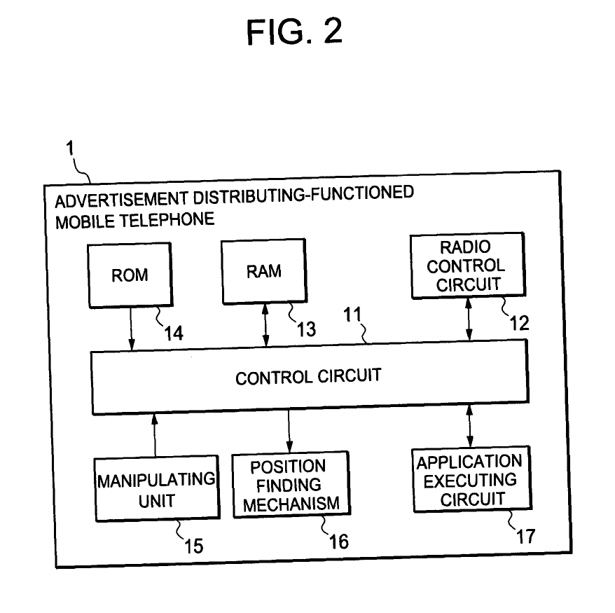

FIG. 2 is a block diagram illustrating the configuration of the advertisement distributing-functioned mobile telephone 1 shown in FIG. 1. In FIG. 2, the internal configuration of the advertisement distributing-functioned mobile telephone 1 capable of finding its own position is illustrated in a simplified way.

The advertisement distributing-functioned mobile telephone 1 is configured of a control circuit 11, a radio control circuit 12 for executing radio transmission/reception with a base station (not shown), a random access memory (RAM) 13, a read only memory (ROM) 14, a manipulating unit 15, a position finding mechanism 16 which may be a GPS position finding circuit for instance, and an application executing circuit 17.

The advertisement distributing-functioned mobile telephone 1 produces with the application executing circuit 17 in its own terminal an advertisement to be distributed. The advertisement distributing-functioned mobile telephone 1 also has a function to find its own position by using the position finding mechanism 16, and to register its position with the data management server 3 from the radio control circuit 12 via the positional information server 2.

The control circuit 11 has a function to control other circuits in its own terminal, another function to produce an advertisement as e-mail information, and still another function to select target users of the advertisement on the basis of user information acquired from the positional information server 2. The radio control circuit 12 has a function to acquire user information from the positional information server 2 and to distribute an advertisement by e-mail.

The RAM 13 is a storage area for storing the functions of the mobile telephone and settings regarding positional information; the ROM 14 is a program area for recording computer-executable programs; and the manipulating unit 15 has functions for manipulating its own terminal.

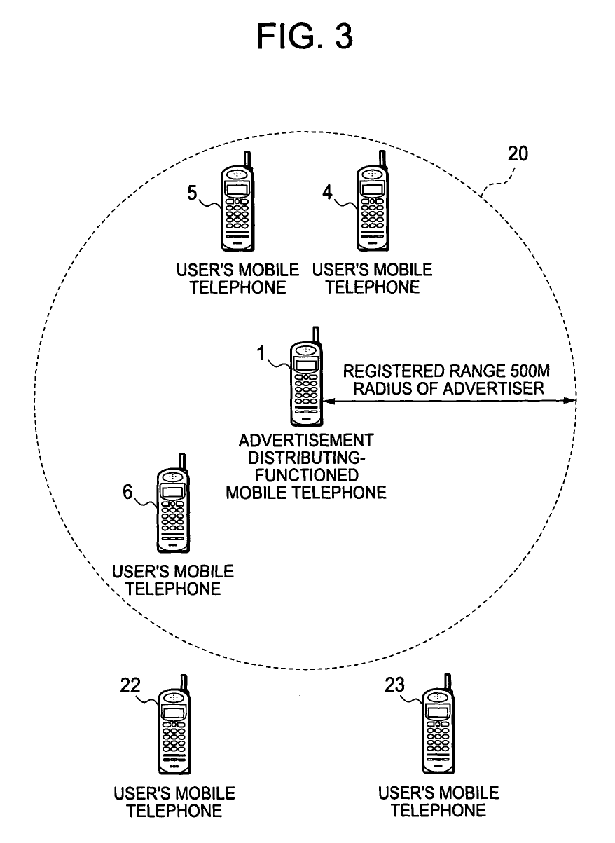

FIG. 3 illustrates an area of registration in the preferred embodiment of the invention. In FIG. 3 are shown the position in which the advertisement distributing-functioned mobile telephone 1 registered a target area with the data management server 3 via the positional information server 2 and the position of each user.

The advertisement distributing-functioned mobile telephone 1 registers with the data management server 3 a request for “information on users present in our 500 m radius (a target area 21)”. The users present at the time of this registration within the 500 m radius of the advertisement distributing-functioned mobile telephone 1 are the user's mobile telephone 4, the user's mobile telephone 5 and the user's mobile telephones 6. As the user's mobile telephone 22 and the user's mobile telephone 23 are outside the 500 m radius, they do not belong to the desired target area of the advertisement distributing-functioned mobile telephone 1.

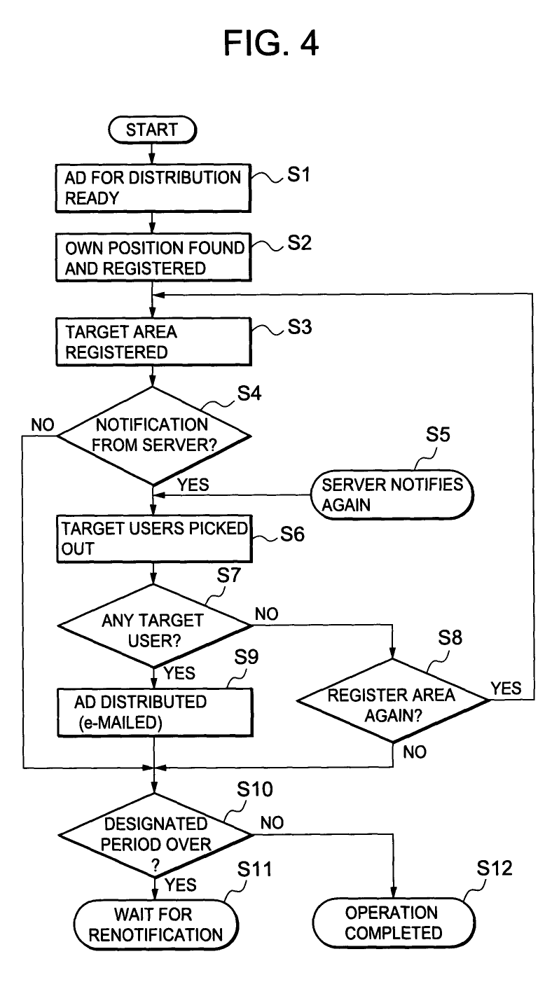

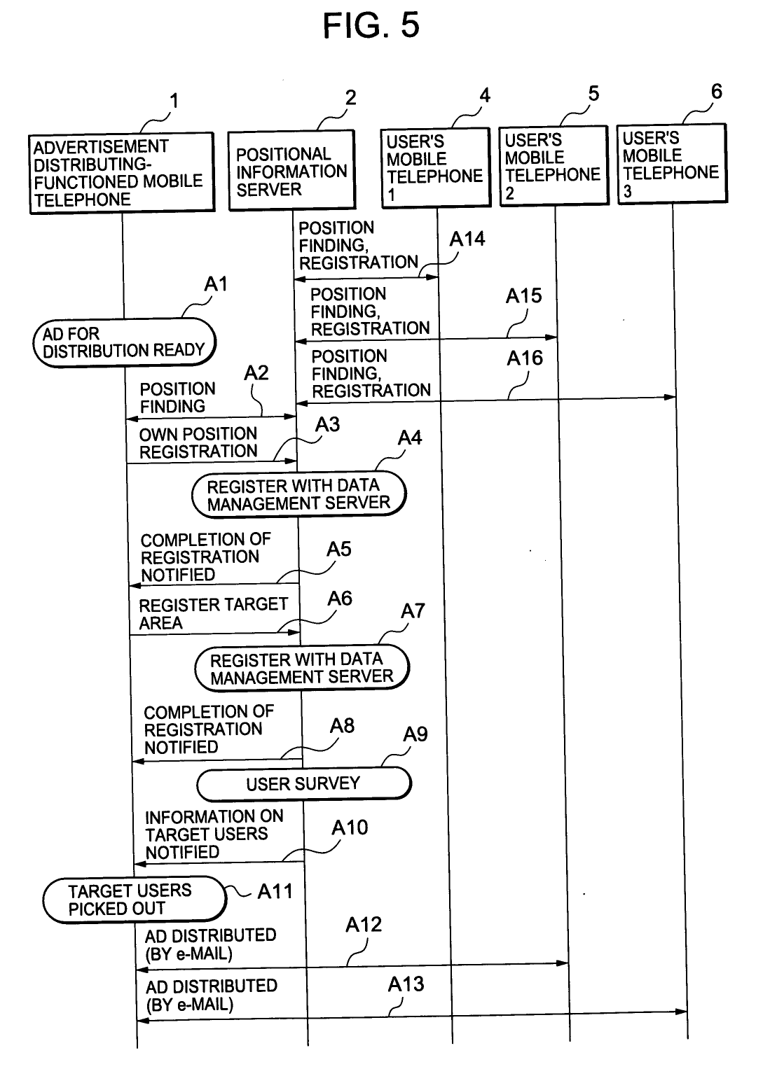

FIG. 4 is a flow chart and FIG. 5 is a sequence chart, both showing the operation of the preferred embodiment of the invention. Now will be described the operation of the preferred embodiment of the invention with reference to these FIG. 1 through FIG. 5. The steps of processing shown in FIG. 4 and FIG. 5 are realized by the execution of a program in the ROM 1-4 by a computer in the control circuit 11.

The advertisement distributing-functioned mobile telephone 1 produces an advertisement to be distributed with the application executing circuit 17 in its own terminal and stores it into the RAM 13. If there is an already produced advertisement, it will be let stand by as it is in the RAM 13 (Step S1 in FIG. 4).

The positional information server 2 to provide positional information service is a relay server providing position search service and the like. The advertisement distributing-functioned mobile telephone 1 either finds its own position with the position finding mechanism 16 or registers information on an already found position from the radio control circuit 12 with the data management server 3 via the positional information server 2 (Step S2 in FIG. 4).

Next, the control circuit 11 of the advertisement distributing-functioned mobile telephone 1 determines the advertising target area and the period of notifying user information. For instance, the control circuit 11 of the advertisement distributing-functioned mobile telephone 1 determines the 500 m radius of its own terminal to be the target area 21 in accordance with a command from the manipulating unit 15, generates target area information that “information on users present in the target area 21, which is our 500 m radius, is desired”, and transmits this information to the data management server 3 via the positional information server to be registered (Step S3 in FIG. 4). Then, the control circuit 11 generates information on the user information notifying duration (e.g. two hours), and transmits it to the data management server 3 together with the target area information to be registered.

The data management server 3, upon registration of the positional information, the target area information and the notifying duration from the advertisement distributing-functioned mobile telephone 1, surveys users in the target area 21, and transmits in-area user information [the user's mobile telephones 4 through 6] to the advertisement distributing-functioned mobile telephone 1 via the positional information server 2. At this time, the user's mobile telephone 22 and the user's mobile telephone 23 are not covered because they are out of the target area 21.

The advertisement distributing-functioned mobile telephone 1, upon receiving from the positional information server 2 information on users present in the target area 21 [the user's mobile telephones 4 through 6] (Step S4 in FIG. 4), causes the control circuit 11 to pick out only those users who are the targets of distribution (Step S6 in FIG. 4). The advertisement distributing-functioned mobile telephone 1, if no notification comes from the positional information server 2 (Step S4 in FIG. 4) but the duration designated at the time of registration (two hours) has not yet lapsed (Step S10 in FIG. 4), waits for a notification from the positional information server 2 (Step S11 in FIG. 4).

The control circuit 11 of the advertisement distributing-functioned mobile telephone 1, if it judges that there is no distribution target user (Step S7 in FIG. 4), further judges whether or not to register the target area 21 again (Step S8 in FIG. 4) and, if the target area 21 is to be registered again by inputting from the manipulating unit 15, returns to Step S3 to register with the data management server 3 target area information that “information on users present in the target area 21, which is our 500 m radius, is desired”.

The control circuit 11 of the advertisement distributing-functioned mobile telephone 1, if it judges that there is any target user (Step S7 in FIG. 4), reads the advertisement produced at Step S1 out of the RAM 13, and distributes (transmits) it from the radio control circuit 12 by e-mail only to the selected target users (Step S9 in FIG. 4).

The control circuit 11, if the two hour duration of user notification registered at the same time as the registration of the target area information with the data management server 3 has not lapsed by this time (Step S10 in FIG. 4), waits for a notification of new user information from the positional information server 2 (Step S11 in FIG. 4) The positional information server 2, if a new user is found in the target area within the two hour user notification duration registered by the advertisement distributing-functioned mobile telephone 1, notifies that user information to the advertisement distributing-functioned mobile telephone 1 as occasion arises (Step S5 in FIG. 4).

Next will be described the flow of advertisement distribution using the preferred embodiment of the present invention with reference to the sequence of operation charted in FIG. 5. In the mobile communication system embodying the invention in this mode, it is supposed that positional information on each of, for instance, the user's mobile telephone 4, the user's mobile telephone 5 and the user's mobile telephone 6 is already registered with the data management server 3 via the positional information server 2 (see A14 through A16 in FIG. 5) and is utilized for the purpose.

The advertisement distributing-functioned mobile telephone 1 either produces an advertisement with the application executing circuit 17 in its own terminal or keeps one produced in advance standing by in the RAM 13 (see A1 in FIG. 5). The advertisement distributing-functioned mobile telephone 1 either finds its own position (see A2 in FIG. 5) or sends a request for registration to the positional information server 2 to register with the data management server 3 information on the position found in advance (see A3 in FIG. 5).

The positional information server 2, when it has received a request for registration from the advertisement distributing-functioned mobile telephone 1, registers with the data management server 3 the positional information on the advertisement distributing-functioned mobile telephone 1 (see A4 in FIG. 5). Upon completion of the registration of the position, the positional information server 2 transmits a notification of the completion of registration to the advertisement distributing-functioned mobile telephone 1 (see AS in FIG. 5).

Then the advertisement distributing-functioned mobile telephone 1, to register target area information on the target area 21 in which the advertisement is to be distributed and information on the user notifying duration, transmits a request for registration containing those items of information to the positional information server 2 (see A6 in FIG. 5). The positional information server 2, when it has received a request for registration of the target area 21 from the advertisement distributing-functioned mobile telephone 1, registers the target area 21 with the data management server 3 (see A7 in FIG. 5), and transmits a notification of the completion of registration to the advertisement distributing-functioned mobile telephone 1 (see A8 in FIG. 5).

The data management server 3, on the basis of the target area 21 registered by the advertisement distributing-functioned mobile telephone 1 via the positional information server 2, surveys users whose registered positions are in that area (see A9 in FIG. 5). In this survey, the user's mobile telephone 22 and the user's mobile telephone 23 are not selected as targets of advertising because they are outside the target area 21 Upon identifying information on the users to be picked out as targets, the data management server 3 notifies the advertisement distributing-functioned mobile telephone 1 of information on the users present in the target area 21 (see A10 in FIG. 5).

Upon acquiring information on users in the target area 21, the advertisement distributing-functioned mobile telephone 1 picks out target users fitting the content of the advertisement (see A11 in FIG. 5). The advertisement distributing-functioned mobile telephone 1 distributes the advertisement by e-mail to only the user's mobile telephone 5 and the user's mobile telephone 6 which have been picked out (see A12 and A13 in FIG. 5).

Thus in this mode of embodying the invention, the advertisement distributing-functioned mobile telephone 1 can distribute an advertisement to users even if it has no PC or server by producing within its own terminal the advertisement intended for distribution and distributing it to users within a preset target area 21.

Furthermore, as this mode of embodying the invention enables the advertisement distributing-functioned mobile telephone 1 to designate so many meters' radius from its own position or an area in which target users are to be identified, it can find the target users even if it moves to another place or is moving, so that the advertiser need not stay in one place to be able to distribute advertising. The radius of the target area can be freely set by inputting from the manipulating unit 15. Moreover, it can designate targets of distribution in terms of the distance from its own position, a preset area or domiciles whichever is the most convenient.

Moreover in this mode of embodying the invention, as the advertisement distributing-functioned mobile telephone 1 has on hand relevant information from the positional information server 2, the frequency of data exchanges can be minimized, and the duration can be designated.

Furthermore, in this mode of embodying the invention, as the advertisement distributing-functioned mobile telephone 1 distributes advertising with its e-mailing function, there is no need for any new software configuration or mounting of a system for the distributing purpose. For this reason, a conventional mobile telephone capable of finding its own position can be used for advertising distribution.

In addition, in this mode of embodying the invention, once the advertisement distributing-functioned mobile telephone 1 finds that there is no target user within the target area 21 registered with the positional information server 2, it can readily accomplish setting to expand or alter the target area 21.

The invention is not limited to the above-described embodiment, but can take many different modes of implementation within the scope of its technological idea. For instance, the advertisement distributing-functioned mobile telephone 1 need not limit its target area to one, but can as well acquire information on a plurality of target areas from the positional information server 2, and distribute to users in each of those target areas an advertisement produced in advance for target users in that area.

The advertisement distributing-functioned mobile telephone 1, after acquiring information on users in the target area 21 from the positional information server 2, can as well transmit the information to the positional information server 2 instead of picking out target users for the advertisement in its own terminal and sending from the terminal the advertisement directly to the users by e-mail. In this way, greater security can be ensured because the positional information server 2 distributes the advertisement according to the user information transmitted from the advertisement distributing-functioned mobile telephone 1, which therefore has no opportunity to know the e-mail addresses of the users.

Furthermore, as the advertisement distributing-functioned mobile telephone 1 can designate a specific area, domiciles or the like as the target area of distribution instead of selecting the area in terms of the distance from itself, it can distribute an advertisement before it arrives in the target area.

As hitherto described, the present invention provides the benefit that the advertiser can distribute its advertisement even if it does not stay in one place because the mobile telephone having a function to find its own position according to the invention can produce at its own terminal advertising information to be distributed, and distribute the advertising information so produced to terminals which fit preset conditions.

While the invention has been described with reference to certain preferred embodiments thereof, it is to be understood that the subject matter encompassed by the invention is not to be limited to those specific embodiments. Instead, it is intended for the subject matter of the invention to include all such alternatives, modifications and equivalents as can be included within the spirit and scope of the following claims.

What is claimed is:

1. A mobile telephone having a position finding circuit for finding its own position, further provided with:
a control circuit for generating advertising information to be distributed, wherein:
said control circuit has a distributing circuit for distributing said advertising information which has been generated to terminals which fit preset conditions.

2. The mobile telephone, as claimed in claim 1, further including:
a circuit for acquiring positional information on said terminals from a positional information server providing positional information service.

3. The mobile telephone, as claimed in claim 2, wherein:
said distributing circuit distributes said advertising information to said terminals via said positional information server.

4. The mobile telephone, as claimed in claim 1, wherein:
said control circuit can freely set the timing of distributing said advertising information.

5. The mobile telephone, as claimed in claim 2, wherein:
said control circuit can freely set the timing of distributing said advertising information.

6. The mobile telephone, as claimed in claim 3, wherein:
said control circuit can freely set the timing of distributing said advertising information.

7. The mobile telephone, as claimed in claim 1, wherein:
said position finding circuit finds the position of the mobile telephone by using a Global Positioning System (GPS).

8. The mobile telephone, as claimed in claim 1, wherein:
said preset conditions permit designation as desired of at least one of the factors including the distance from said position of the mobile telephone, a preset area and domiciles.

9. The mobile telephone, as claimed in claim 2, wherein:
said preset conditions permit designation as desired of at least one of the factors including the distance from said position of the mobile telephone, a preset area and domiciles.

10. The mobile telephone, as claimed in claim 3, wherein:
said preset conditions permit designation as desired of at least one of the factors including the distance from said position of-the mobile telephone, a preset area and domiciles.

11. An advertisement distributing method for a mobile telephone having a function to find its own position, comprising a step of generating advertising information to be distributed, and a step of distribution said advertising information that has been generated to terminals which fit preset conditions.

12. The advertisement distributing method as claimed in claim 11, further including:
a step of acquiring positional information on said terminals from a positional information server providing positional information service.

13. The advertisement distributing method as claimed in claim 12, whereby:
said advertising information is distributed to said terminals via said positional information server at the step of distributing said advertising information.

14. The advertisement distributing method as claimed in claim 11, whereby:
the distribution timing of said advertising information can be freely set.

15. The advertisement distributing method as claimed in claim 12, whereby:
the distribution timing of said advertising information can be freely set.

16. The advertisement distributing method as claimed in claim 13, whereby:
the distribution timing of said advertising information can be freely set.

17. The advertisement distributing method as claimed in claim 11, whereby:
said function to find its own position uses a Global Positioning System (GPS).

18. The advertisement distributing method as claimed in claim 11, whereby:
said preset conditions permit designation as desired of at least one of the factors including the distance from said position of the mobile telephone, a preset area and domiciles.

19. The advertisement distributing method as claimed in claim 12, whereby:
said preset conditions permit designation as desired of at least one of the factors including the distance from said position of the mobile telephone, a preset area and domiciles.

20. The advertisement distributing method as claimed in claim 13, whereby:
said preset conditions permit designation as desired of at least one of the factors including the distance from said position of the mobile telephone, a preset area and domiciles.

21. A distributing system including a mobile telephone having a position finding circuit for finding the position of the mobile telephone and a control circuit for generating an advertisement, and
a positional information server for providing positional information service, wherein:
said positional information server provides positional information on terminals which fit conditions set by said mobile telephone, and
said mobile telephone distributes said advertisement that has been generated to terminals which fit said conditions.

22. The distributing system as claimed in claim 21, wherein:
said mobile telephone includes a distributing circuit for distributing said advertising information to said terminals via said positional information server.

23. The distributing system as claimed in claim 21, wherein:
said control circuit can freely set the timing of distributing said advertising information.

24. The distributing system as claimed in claim 22, wherein:
said control circuit can freely set the timing of distributing said advertising information.

25. The distributing system as claimed in claim 21, wherein:
said position finding circuit uses a Global Positioning System (GPS) to find the position of the mobile telephone.

26. The distributing system as claimed in claim 21, wherein:
said preset conditions permit designation as desired of at least one of the factors including the distance from said position of the mobile telephone, a preset area and domiciles.

27. The distributing system as claimed in claim 22, wherein:
said preset conditions permit designation as desired of at least one of the factors including the distance from said position of the mobile telephone, a preset area and domiciles.
